(19) United States
(12) Patent Application Publication
(10) Pub. No.: US 2010/0092677 A1
(43) Pub. Date: Apr. 15, 2010

(54) CLOTHING PRINT METHOD EMPLOYING INKJET PRINTER, AND CLOTHING PRINT SYSTEM

(76) Inventor: Chizuo Ozawa, Nagano (JP)

Correspondence Address: BUCHANAN, INGERSOLL & ROONEY PC, POST OFFICE BOX 1404, ALEXANDRIA, VA, 22313-1404, US

(21) Appl. No.: 12/519,563

(22) PCT Filed: Dec. 26, 2006
(86) PCT No.: PCT/JP2006/325878

§ 371 Date: Jun. 17, 2009

(51) Int. Cl. B05D 3/12; B41J 29/38; B41J 2/01

(52) U.S. Cl. 427/275; 347/9; 347/102

(57) ABSTRACT

A T shirt stretching tool (4) in a closed state is inserted into a T shirt (5) of print object. The T shirt stretching tool (4) is opened to the right and left, the body portion (51) of the T shirt (5) is spread to the right and left and then the front part (51a) and the back part (51b) of the body portion are stretched to bring about a planar state (step for stretching clothing). The T shirt (5) spread to the right and left by the T shirt stretching tool (4) is then mounted on the medium mount (22) of an ink jet printer (2) while the front part (51a) is directed upward (step for setting clothing). Thereafter, the ink jet printer (2) is driven to print a print image at a set position of the front part (51a) in the body portion (51) of the T shirt (5). Consequently, a pattern can be printed neatly on a T shirt using an ink jet printer.

### TECHNICAL FIELD

The present invention relates to a clothing print method and a clothing print system capable of printing on a T-shirt or other clothing through the use of an inkjet printer.

### BACKGROUND ART

Screen printing is commonly employed when printing a pattern or the like on a T-shirt. Screen printing requires that a plate be fabricated in correspondence with the pattern, and the number of printing steps increases for multi-color printing. A method for sewing pre-dyed cloth is therefore used as a method for making a T-shirt in which various types of different patterns are printed on the entire surface thereof. However, this method has drawbacks of high cost and long manufacturing time.

An arbitrary pattern can easily be printed on the surface of a T-shirt using an inkjet printer. However, since the use of an inkjet printer assumes that printing will be done on paper or another flat surface, it is difficult to neatly print on the surface of a T-shirt that is wrinkled and not flat.

### DISCLOSURE OF THE INVENTION

In view of the foregoing, an object of the present invention is to provide a print method and print system whereby an arbitrary design can be printed using an inkjet printer on a cloth article, particularly clothing that is shaped so as to have a body portion, such as a T-shirt or the like.

According to the present invention for overcoming the drawbacks described above, there is provided a cloth article print method for printing on the surface of clothing or another cloth article using an inkjet printer, and the cloth article print method is characterized in comprising a stretching step of mounting a stretching tool at an area to be printed in a cloth article and using the stretching tool to spread the area to be printed, thereby bringing about a flat state in the area to be printed; a cloth article setting step of mounting the area to be printed of the cloth article on a medium mount of an inkjet printer; and a print step of printing on the area to be printed of the cloth article through the use of the inkjet printer; wherein the stretching step is performed before or after the cloth article setting step.

When the stretching step is performed before the cloth article setting step, in the stretching step, the stretching tool capable of stretching in a predetermined direction is mounted at the area to be printed of the cloth article, and using the stretching tool to spread the area to be printed creates a flat state in the area to be printed; and in the cloth article setting step, the area to be printed of the cloth article stretched by the stretching tool is mounted on the medium mount of the inkjet printer.

When the stretching step is performed after the cloth article setting step, in the cloth article setting step, the area to be printed of the cloth article is affixed to a medium mount surface of the medium mount of the inkjet printer; and in the stretching step, the stretching tool is mounted in the area to be printed of the cloth article adhered to the medium mount, and the area to be printed is spread into a flat state.

According to the present invention, there is also provided a clothing print method for using an inkjet printer to print on clothing that has a body portion, and the clothing print method is characterized in comprising a clothing stretching step of inserting an expandable clothing stretching tool in the body portion of a clothing article, expanding the clothing stretching tool, and spreading out the body portion of the clothing, thereby stretching a front part or back part of the body portion of the clothing into a flat state; a clothing setting step of mounting the clothing spread by the clothing stretching tool on a medium mount of an inkjet printer; and a print step of printing on a front part or back part of the body portion of the clothing through the use of the inkjet printer.

In the present invention, the fabric of the front part or back part of the body portion can be kept in a flat state by using the clothing stretching tool to spread the body portion of the clothing. Consequently, print data of an arbitrary design or the like can be neatly printed without omission using an inkjet printer on the fabric that is kept in a flat state.

In the method of the present invention, the clothing stretching tool provided with a sleeve insertion panel capable of spreading a sleeve portion of the clothing into a flat state is used in the clothing stretching step to bring about a flat state in an area to be printed in a front part of the body portion and sleeve portion of the clothing, or to bring about a flat state in an area to be printed in a back part of the body portion and sleeve portion of the clothing; and in the print step, printing is performed in the area to be printed of the body portion and sleeve portion of the clothing that is in a flat state.

The use of a clothing stretching tool provided with a sleeve insertion panel enables printing on the entire surface of the front part of the body portion and sleeve portion of the clothing.

The method of the present invention is characterized in comprising a print position setting step of capturing an image of the clothing mounted on the medium mount and setting a print position on the basis of the captured image, prior to the print step. Print data can be printed in a target area of the clothing. Printing may also, of course, be applied in a random position, in which an image is not captured to specify the print position, or so as to extend beyond the area of the clothing, for example.

The method of the present invention is characterized in comprising a heating or drying step of fixing the ink discharged onto the clothing, the heating or drying step being performed after the print step. The clothing may be pressed and dried by an iron, for example.

The method of the present invention is applied particularly to printing on a T-shirt.

According to the present invention, there is also provided a clothing print system for printing on clothing by the method described above, and the clothing print system is characterized in comprising a clothing stretching tool capable of extending to the left and right, having been inserted into the body portion, in order to spread the body portion of a clothing article to the left and right into a flat state; and an inkjet printer; wherein the inkjet printer is provided with an inkjet head, a medium mount for mounting the clothing article printed by the inkjet head, and control means for controlling the driving of the inkjet head in order to print predetermined print data on a clothing article that is mounted on the medium mount.

The clothing print system preferably has imaging means for capturing an image of a clothing article mounted on the medium mount, wherein the control means of the inkjet printer determines the print position of print data on the basis of a captured image acquired by the imaging means. Of course, a configuration may also be adopted in which a template including numerous patterns or other print images is displayed on a display, and a print image is selected.

The clothing print system preferably has heating or drying means for heating or drying a printed surface of a clothing article mounted on the medium mount.

The inkjet printer used may comprise conveyance means for conveying the medium mount in sequence through the print position of the inkjet head and the position of heating or drying by the heating or drying means.

The clothing stretching tool employed by the present invention is characterized in that it comprises an elongated rectangular plate-shaped base, a pair of slide panels capable of sliding to the left and right along a surface of the plate-shaped base, and a slide mechanism for allowing the slide panels to slide toward or away from each other.

In order to enable printing on the sleeve portions of the clothing as well, a clothing stretching tool may be used in which a sleeve insertion panel for inserting into a sleeve portion of a clothing article is formed integrally with or attached to each of the slide panels.

The slide mechanism preferably comprises an operating lever that is operated in the direction orthogonal to the sliding direction of the slide panels in order to slide the slide panels; and restraining means for restraining the operating lever in an operating position. The distal end of the operating lever may be formed so as to protrude from the bottom of the clothing when the clothing stretching tool is inserted in the body portion of the clothing. When the operating lever is released with the clothing in a spread state, the spread state is maintained by the restraining means. Consequently, a state in which the clothing is spread out to the left and right can easily be formed by moving the operating lever a predetermined amount.

According to the present invention as described above, the front part or back part of the body portion of a clothing article can be kept in a flat state by using the clothing stretching tool to spread the clothing to the left and right. Since the gap between the inkjet head of the inkjet printer and the printed surface part of the clothing can be kept constant in this state, printing can be neatly applied to the clothing.

### BRIEF DESCRIPTION OF THE DRAWINGS

FIG. 1 is a view showing the overall structure of a T-shirt print system to which the present invention is applied;

FIGS. 2(a) and 2(b) are a plan view and sectional view, respectively, showing the T-shirt stretching tool shown in FIG. 1;

FIG. 3 is a view showing the state in which the T-shirt stretching tool shown in FIG. 2 is used;

FIG. 4 is a view showing another example of a T-shirt stretching tool;

FIG. 5 is a view showing another example of a T-shirt stretching tool; and

FIG. 6 is a view showing another example of a T-shirt stretching tool.

### BEST MODE FOR CARRYING OUT THE INVENTION

An embodiment of a T-shirt print system to which the present invention is applied will be described hereinafter with reference to the drawings.

(Overall Structure)

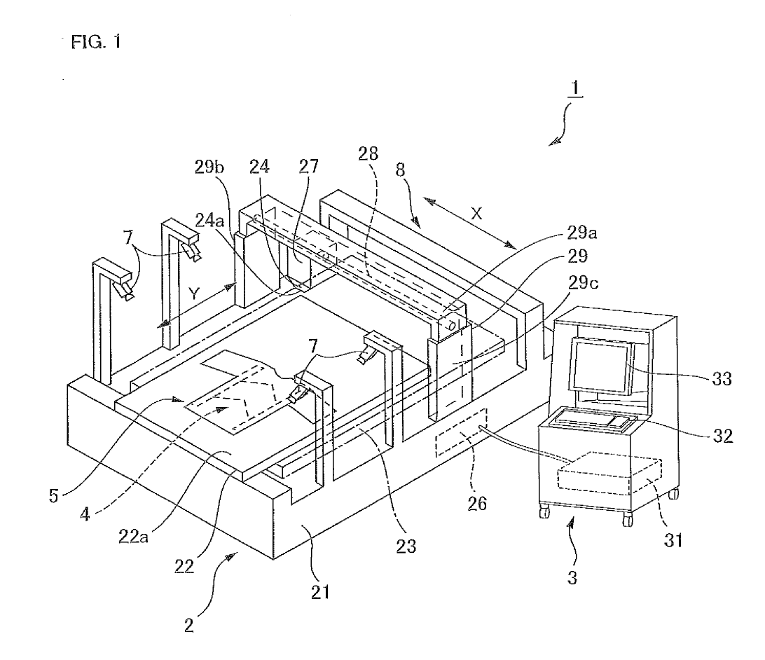

FIG. 1 is a view showing the overall structure of a T-shirt print system. The T-shirt print system 1 has an inkjet printer 2, a printer control device 3, and a T-shirt stretching tool 4.

The inkjet printer 2 has a rectangular device table 21; an elongated rectangular medium mount 22 that is horizontally supported by the device table 21 so as to be able to move reciprocally in the forward-reverse direction (Y direction) of a printer; a conveyance mechanism 23 for conveying the medium mount 22 in the forward-reverse direction; an inkjet head 24 for printing on a T-shirt 5 that is set on the medium mount 22; and a drive control unit 26.

The inkjet head 24 is mounted to a carriage 27 so that an inkjet nozzle surface 24a of the inkjet head 24 faces downward. The carriage 27 is capable of reciprocal movement in the X direction along a guide shaft 28 that is extended in the width direction (X direction) of the printer. A carriage motor (not shown) is set in a ceiling portion 29a of a support frame 29 that supports the carriage 27. The ceiling portion 29a of the support frame 29 is attached so as to be able to ascend and descend with respect to left and right end panel parts 29b, 29c. The gap between a mounting surface 22a of the medium mount 22 and the inkjet nozzle surface 24a of the inkjet head 24 mounted on the carriage 27 can be adjusted by raising and lowering the ceiling portion 29a.

The T-shirt 5 in a state of being spread to the left and right by the T-shirt stretching tool 4 is mounted on the medium mount 22. In this state, the T-shirt 5 can be printed while the medium mount 22 is moved in the Y direction, and the inkjet head 24 is moved back and forth in the X direction by the carriage 27.

A plurality of CCD cameras 7 are mounted to the device table 21, and the CCD cameras 7 capture an image of the T-shirt 5 that is mounted on the mounting surface 22a of the medium mount 22 in an initial position. A drying unit 8 provided with an infrared lamp or the like is provided in a position further to the rear on the device table 21 than the inkjet head 24. The drying unit 8 dries the printed surface of the T-shirt 5 on which printing has been completed, and fixes the ink.

The printer control device 3 is based on a personal computer, and has a control unit 31 that houses a processor or the like; a keyboard or other input device 32; and a display device 33. An image of the T-shirt 5 captured by the CCD cameras 7 can be displayed on the display device 33. In the printer control device 3, a display in which the captured image of the T-shirt 5 is superimposed on a print image is displayed on a display screen of the display device 33. An operator can adjust the position of the print image in relation to the T-shirt image via the input device 32 and determine the print position of the print image. The control unit 31 controls the driving and printing operation of the conveyance mechanism 23 and the inkjet head 24 so that the print image is printed in the determined print position.

Various types of print images are stored in an image memory of the control unit 31, and the operator selects one of the print images, and can thereby print the image on the T-shirt 5. It is also possible, of course, for an arbitrary image to be read by a scanner or other image reading means, and for the image to be printed. Print data may also be acquired from the outside via a communication line and printed on the T-shirt.

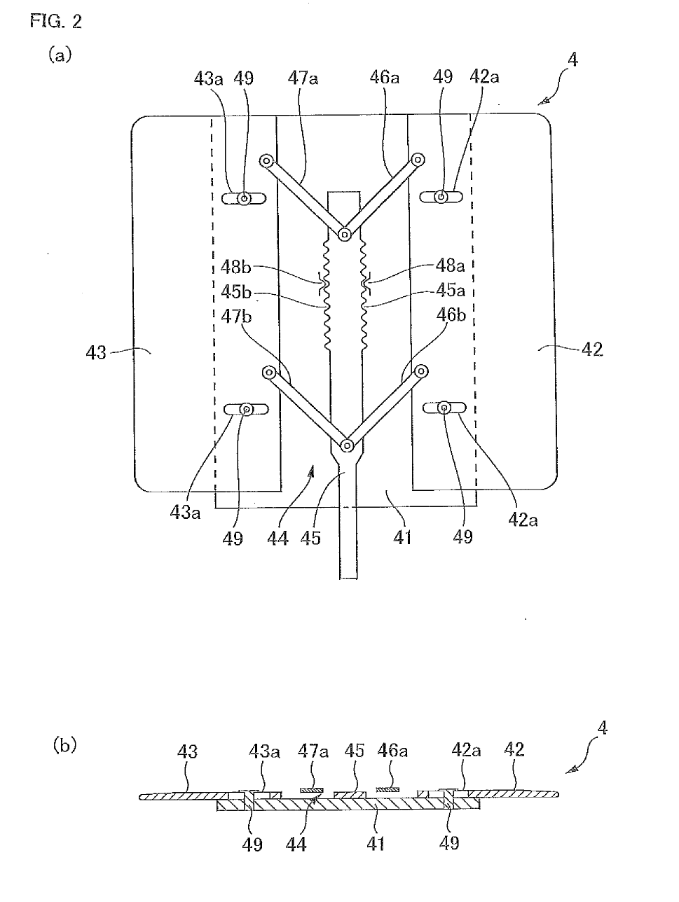

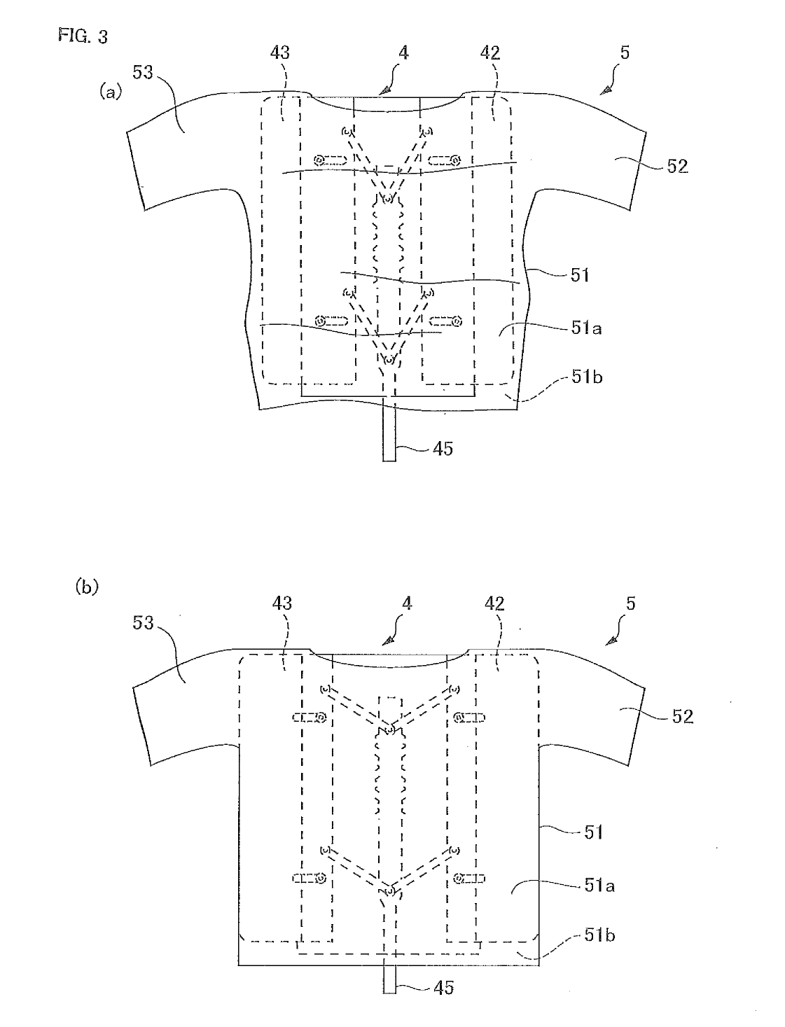

FIGS. 2(a) and 2(b) are a plan view and sectional view, respectively, showing the T-shirt stretching tool 4, and FIGS. 3(a) and 3(b) are views showing a state in which the T-shirt stretching tool 4 is used. The T-shirt stretching tool 4 is inserted into the body portion 51 of the T-shirt 5 from the bottom thereof, and by extending the T-shirt stretching tool 4 to the left and right, the T-shirt 5 is spread to the left and right, and the front part 51a or back part 51b of the body portion 51 is kept in a flat state.

The present T-shirt stretching tool 4 is provided with an elongated rectangular base plate 41 made of stainless steel; slide panels 42, 43 made of resin that can open and close to the left and right along the surface of the base plate 41; and an opening and closing mechanism 44 for opening and closing the slide panels 42, 43 in the width direction. Pairs of guide holes 42a, 43a elongated in the transverse direction are formed in the slide panels 42, 43, respectively. Four guide pins 49 attached to the base plate 41 are slidably inserted, one into each of the guide holes 42a, 43a.

The opening and closing mechanism 44 is provided with an operating lever 45 that extends in the longitudinal direction, and two pairs of links 46a, 46b, 47a, 47b. The operating lever 45 is attached so as to be able to slide in the longitudinal direction along the surface of the base plate 41. A plurality of wave-shaped notches 45a, 45b for regulating the operating position are formed on the left and right edges of the operating lever 45. A pair of locking tabs 48a, 48b that are fitted by spring force on one pair of left and right notches 45a are attached to the base plate 41. Consequently, the operating lever 45 is kept immobile in a predetermined operating position in the longitudinal direction by the restraining means composed of the notches and locking tabs.

The pair of links 46a, 46b are extended parallel to each other between the operating lever 45 and one of the slide panels 42, and a four-jointed link mechanism is thereby formed. In the same manner, the other pair of links 47a, 47b are extended parallel to each other between the operating lever 45 and the other slide panel 43, and also form a four-jointed link mechanism. When the operating lever 45 is moved in the longitudinal direction, the left and right slide panels 42, 43 slide in opposite directions and open and close.

The T-shirt stretching tool 4 thus configured is inserted from below into the body portion 51 of the T-shirt 5 to be printed, in a state in which the left and right slide panels 42, 43 are closed, as shown in FIG. 3(a). The operating lever 45 is then pushed upward, and the left and right slide panels 42, 43 open. As a result, the body portion 51 of the T-shirt 5 is spread to the left and right, and the front part 51a and back part 51b of the T-shirt body portion 51 that is extended between the left and right slide panels 42, 43 are stretched and kept in a flat state, as shown in FIG. 3(b).

The base plate 41, slide panels 42, 43, and links 46a, 46b, 47a, 47b of the T-shirt stretching tool 4 are preferably rounded or tapered at the corners thereof so as not to damage the T-shirt 5.

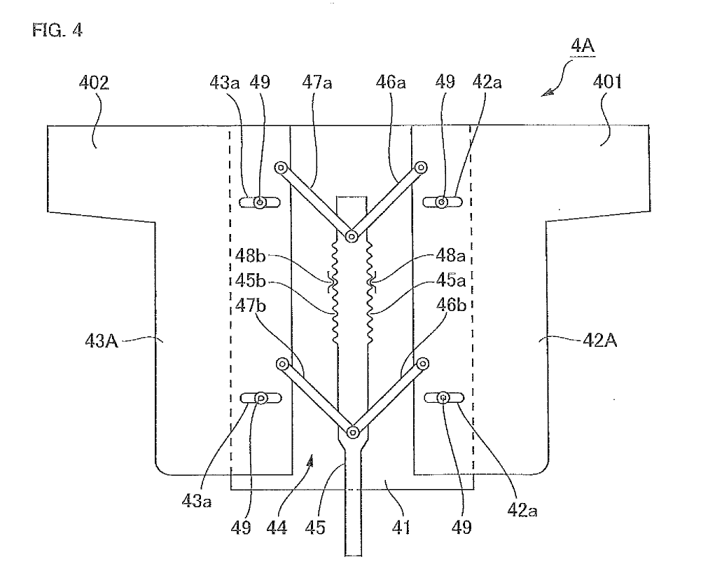

When printing is also applied to left and right sleeve portions 52, 53 of the T-shirt 5, a T-shirt stretching tool must be used that is also capable of maintaining the sleeve portions 52, 53 in a flat state. FIG. 4 is a plan view showing a T-shirt stretching tool for this purpose.

Since the T-shirt stretching tool 4A shown in FIG. 4 has the same basic structure as the T-shirt stretching tool 4 described above, the same reference numerals are used to refer to corresponding parts thereof, and no redundant description will be given. Sleeve insertion panels 401, 402 capable of inserting into the sleeve portions 52, 53 are formed integrally with left and right slide panels 42A, 43A in the T-shirt stretching tool 4A. When the sleeve insertion panels 401, 402 are inserted into the sleeve portions 52, 53 of the T-shirt 5, the sleeve portions 52, 53 are spread in a flat state and kept flat.

The left and right sleeve insertion panels 401, 402, instead of being formed integrally with the slide panels 42A, 43A, may be attached to the slide panels 42A, 43A so as to be foldable or capable of sliding in a protruding or retracted state.

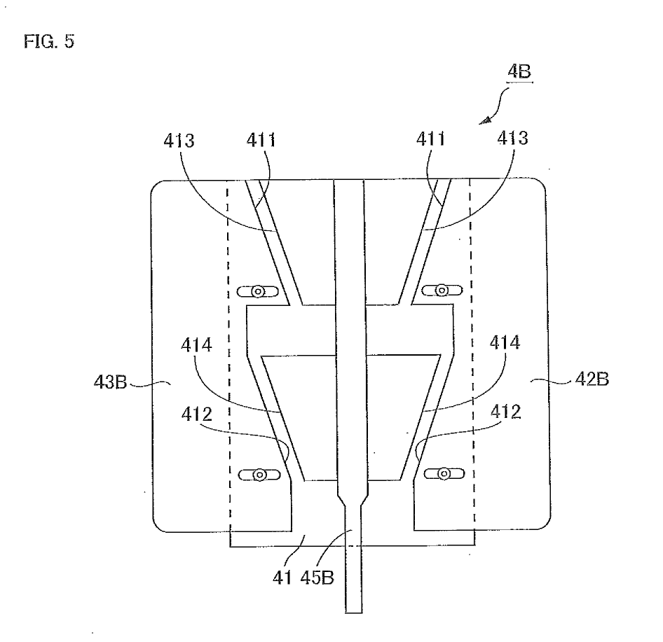

A mechanism other than the four-jointed link mechanism described above may also be used as the mechanism for opening and closing the left and right slide panels 42, 43 or slide panels 42A, 43A. For example, a configuration may be employed in which inclined surfaces 411, 412 are formed on the inside ends of a pair of slide panels 42B, 43B, and inclined surfaces 413, 414 capable of sliding along the inclined surfaces 411, 412 are formed on an operating lever 45B, as shown in FIG. 5. In this case as well, when the operating lever 45B is pulled, the left and right slide panels 42B, 43B are able to open to the left and right, and when the operating lever 45B is pushed upward, the left and right slide panels 42B, 43B can be closed.

When a T-shirt is spread using the T-shirt stretching tool shown in FIGS. 2, 4, and 5, the area to be printed can be easily and reliably made flat by preparing a medium mount 22 on which a weakly adhesive adhesion surface is formed on the mounting surface 22a, adhering the T-shirt 5 in a spread state to the mounting surface 22a, and then installing the T-shirt stretching tool and spreading the T-shirt 5 until wrinkles are eliminated.

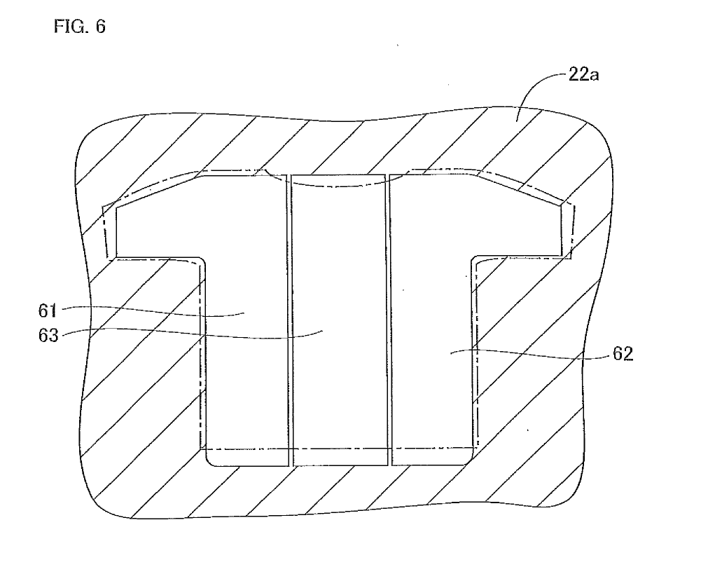

In this case, the T-shirt 5 can also be spread using two left-right symmetrical stretching panels 61, 62 that are shaped so as to correspond to sleeves, and a substantially rectangular stretching panel 63 that is placed between the stretching panels 61, 62, as shown in FIG. 6. In this case, the T-shirt 5 is spread and adhered to a sticky mounting surface 22a so that the area of the T-shirt 5 to be printed faces upward. The left and right stretching panels 61, 62 are then inserted. Lastly, the stretching panel 63 is pushed in between the stretching panels 61, 62, the left and right stretching panels 61, 62 are pushed out to both sides, and the T-shirt 5 is spread flat to the left and right.

(Printing Operation)

The operations involved in printing a T-shirt 5 using the present T-shirt print system 1 will now be described. First, the closed T-shirt stretching tool 4 is inserted in the T-shirt 5 to be printed, the T-shirt stretching tool 4 is opened, and the body portion 51 of the T-shirt 5 is spread to the left and right, whereby the front part 51a and back part 51b of the body portion are stretched into a flat state (clothing stretching step). When the T-shirt stretching tool 4A is used, both sleeve portions 52, 53 are also stretched into a flat state, and the desired printing can be applied to the front parts or back parts of the sleeve portions as well.

The T-shirt 5 that is spread to the left and right by the T-shirt stretching tool 4 is then placed on the mounting surface 22a of the medium mount 22 of the inkjet printer 2 (clothing setting step). When printing is applied to the front part 51a of the body portion 51 of the T-shirt 5, for example, the T-shirt 5 is mounted so that the body portion 51 faces upward.

The operator selects a print image in the printer control device 3 before or after the setting step such as described above.

The T-shirt 5 mounted on the medium mount 22 is then imaged by the CCD cameras 7 and displayed in a superposed state with the selected print image on the screen of the display device 33 of the printer control device 3. The operator adjusts the position of the print image via the input device 32, and sets the print position of the print image (print position setting step). The size of the print image may be increased or decreased to fit the size of the T-shirt. A configuration may also be adopted to enable the color of the print image to be changed on the screen.

The inkjet printer 2 is then driven and printing is performed. Specifically, the conveyance mechanism 23 activates and conveys the medium mount 22 to the print position of the inkjet head, the inkjet head 24 is also activated synchronously with the conveyance of the medium mount 22, and the print image is printed in the set position in the front part 51a of the T-shirt body portion 51.

The printed T-shirt 5 is conveyed through the drying unit 8. While passing through the drying unit 8, the printed surface of the T-shirt 5 is dried, and the ink is fixed (drying step).

The clothing print method and clothing print system of the present invention may be applied to printing of clothing other than a T-shirt. For example, the present invention may be applied to printing the front part or back part of clothing such as a sweater or the like that is provided with a body portion.

The present invention may also be applied to printing of cloth articles other than clothing. For example, the present invention may be applied to printing of hats, gloves, socks, belts, pet clothing, and various other types of cloth articles.

1. A cloth article print method for printing on the surface of clothing or another cloth article using an inkjet printer, comprising:
a stretching step of mounting a stretching tool at an area to be printed in a cloth article and using the stretching tool to spread said area to be printed, thereby bringing about a flat state in the area to be printed;
a cloth article setting step of mounting said area to be printed of said cloth article on a medium mount of an inkjet printer; and
a print step of printing on said area to be printed of said cloth article through the use of said inkjet printer; wherein
said stretching step is performed before or after said cloth article setting step.

2. The cloth article print method according to claim 1,
wherein said stretching step is performed before said cloth article setting step;
in the stretching step, said stretching tool capable of stretching in a predetermined direction is mounted at said area to be printed of said cloth article, and a flat state is brought about in the area to be printed by using the stretching tool to spread said area to be printed; and
in said cloth article setting step, said area to be printed of said cloth article stretched by said stretching tool is mounted on the medium mount of said inkjet printer.

3. The cloth article print method according to claim 1,
wherein said stretching step is performed after said cloth article setting step;
in said cloth article setting step, said area to be printed of said cloth article is affixed to a medium mount surface of said medium mount of said inkjet printer; and
in said stretching step, said stretching tool is mounted in said area to be printed of said cloth article adhered to said medium mount, and the area to be printed is spread into a flat state.

4. A clothing print method for using an inkjet printer to print on clothing that has a body portion, comprising:
a clothing stretching step of inserting an expandable clothing stretching tool in the body portion of a clothing article, expanding the clothing stretching tool, and spreading out the body portion of the clothing, thereby stretching a front part or back part of the body portion of the clothing into a flat state;
a clothing setting step of mounting said clothing spread by said clothing stretching tool on a medium mount of an inkjet printer; and
a print step of printing on a front part or back part of said body portion of said clothing through the use of said inkjet printer.

5. The clothing print method according to claim 4,
wherein said clothing stretching tool provided with a sleeve insertion panel capable of spreading a sleeve portion of the clothing into a flat state is used in said clothing stretching step to bring about a flat state in an area to be printed in a front part of the body portion and sleeve portion of the clothing, or to bring about a flat state in an area to be printed in a back part of the body portion and sleeve portion of the clothing; and
in said print step, printing is performed in said area to be printed of the body portion and sleeve portion of said clothing that is in a flat state.

6. The clothing print method according to claim 4, comprising a print position setting step of capturing an image of said clothing mounted on said medium mount and setting a print position on the basis of the captured image, prior to said print step.

7. The clothing print method according to claim 4, comprising a heating or drying step of fixing the ink discharged onto said clothing, the heating or drying step being performed after said print step.

8. The clothing print method according to, claim 4 wherein said clothing to be printed is a T-shirt.

9. A clothing print system for printing on clothing by the method according to claim 4, comprising:
a clothing stretching tool capable of extending to the left and right, having been inserted into the body portion, in order to spread the body portion of a clothing article to the left and right into a flat state; and
an inkjet printer; wherein
the inkjet printer is provided with an inkjet head, a medium mount for mounting the clothing article printed by the inkjet head, and control means for controlling the driving of said inkjet head in order to print predetermined print data on a clothing article that is mounted on the medium mount.

10. The clothing print system according to claim 9, comprising imaging means for capturing an image of a clothing article mounted on said medium mount; wherein
said control means of said inkjet printer determines the print position of print data on the basis of a captured image acquired by said imaging means.

11. The clothing print system according to claim 9, comprising heating or drying means for heating or drying a printed surface of a clothing article mounted on said medium mount.

12. The clothing print system according to claim 11, wherein said inkjet printer comprises conveyance means for conveying said medium mount in sequence through the print position of said inkjet head and the position of heating or drying by said heating or drying means.

13. The clothing print system according to claim 9, wherein said clothing stretching tool comprises:
an elongated rectangular plate-shaped base;
a pair of slide panels capable of sliding to the left and right along a surface of the plate-shaped base; and
a slide mechanism for allowing the slide panels to slide toward or away from each other.

14. The clothing print system according to claim 9, wherein a sleeve insertion panel for inserting into a sleeve portion of a clothing article is formed integrally with or attached to each of said slide panels.

15. The clothing print system according to claim 13, wherein said slide mechanism comprises:
an operating lever that is operated in the direction orthogonal to the sliding direction of the slide panels in order to slide said slide panels; and
restraining means for restraining the operating lever in an operating position.
